(19) United States
(12) Patent Application Publication
(10) Pub. No.: US 2007/0009097 A1
(43) Pub. Date: Jan. 11, 2007

(54) Information carrier

(76) Inventors: Steven Badger, Towcester (GB); Robert Michael Stephens, Barton-under-Needwood (GB)

Correspondence Address: MERCHANT & GOULD PC, P.O. BOX 2903, MINNEAPOLIS, MN, 55402-0903, US

(21) Appl. No.: 11/148,507

(22) Filed: Jun. 9, 2005

(51) Int. Cl. H04M 15/06; H04M 1/56

(52) U.S. Cl. 379/142.01

(57) ABSTRACT

An information carrier for application to a meat transporting hook assembly for use in a meat processing method. The information carrier is adapted for application to a hook assembly having a wheel, a wheel mounting embracing a portion of the wheel and including a strap, and a hook depending from the strap. The information carrier includes a first and second portion. The first portion is for mounting and locating the carrier upon the strap and the second portion is for carrying an information storage device for retaining information about meat held on the hook.

### BACKGROUND OF THE INVENTION

The present invention relates to an information carrier for application to a meat transporting hook assembly and to a method of retaining information about meat held on the hook. In particular, the invention relates to information carriers for application to a meat transporting hook assembly of a kind that is widely used in particular but not exclusively in the USA, having a wheel, a wheel mounting embracing a portion of the wheel comprising a strap (also known as a hook body), and a hook depending from the strap.

There exists a need for systems for retaining information about meat held on a meat hook in order to track meat held on a hook for food safety and quality assurance purposes. A number of systems have been developed for the identification of hook assemblies including marking the strap of a hook assembly with a machine readable pattern of holes as described in U.S. Pat. No. 5,498,202; marking the hook assembly with a bar code as described in U.S. Pat. No. 6,267,661 B1; or numbering the hook assemblies. Difficulties have been experienced in reading the information provided on such systems as a clear line of sight is required.

Systems for tracking hook assemblies using RFID (radio frequency identification) devices have been also been developed that avoid the need for a clear line of sight. U.S. Pat. No. 6,452,497 B1 describes housing an RFID transponder within a space above the wheel of a hook assembly formed in the turn in the strap of the wheel mounting between a main portion and a return portion. U.S. Pat. No. 6,452,497 B1 also describes fitting the transponder in a hole drilled in the strap of the wheel mounting. U.S. Pat. No. 5,781,112 describes tagging of standard meat hook assemblies in which a RFID transmitter encapsulated within a moulded body is attached to the wheel mounting. The moulded body is inserted into a threaded, cylindrical receptacle that is welded to the strap of the wheel mounting. U.S. Pat. No. 6,494,305 B1 describes a carcass-tracking apparatus including an RFID transponder that is attached to the strap of a wheel mounting. The transponder is sealed in a metallic enclosure in a housing with an encapsulant material. The housing is attached to the strap by adhesive, screws or welding so that the transponder is offset from the metal strap of the wheel mounting to improve the electrical performance of the transponder. In order to read and/or write information to/from some information-storage devices, such as passive RFID transponders, an external inductive aerial is used electronically to couple to the device, activating a chip contained therein, which can require close proximity between the aerial and the device. Consistent positioning of the devices has proved difficult to achieve in practice and, furthermore, in certain of the prior art arrangements a device which was initially precisely positioned can easily become dislodged to a different position. A further difficulty encountered in mounting information-storage devices on meat transporting hook assemblies is that the significant metallic bulk of the hook assemblies, the straps of which necessarily comprise thick bars of metal that are capable of supporting the weight of an animal carcass, can cause interference, or shielding of the information-storage device. There exists a need for a system of carrying an RFID transponder and other types of information-storage devices on a meat hook assembly that is capable of withstanding the harsh environment of a meat processing plant including mechanical shock, extremes of temperature and exposure to highly corrosive cleaning materials, and yet is simple to apply in a consistent location. Furthermore, there is a need for a system carrying a storage device in a way that enables a strong and reproducible signal to be obtained from electronically coupling to the storage device in order to read and/or write from/to the device.

### SUMMARY OF THE INVENTION

The invention provides an information carrier for application to a meat transporting hook assembly for use in a meat processing method and a meat processing method using the information carrier. The information carrier is suitable for application to a hook assembly having a wheel, a wheel mounting embracing a portion of the wheel and comprising a strap (also known as a hook body), and a hook depending from the strap. The information carrier comprises a first portion for mounting the carrier upon the strap and a second portion for carrying an information-storage device for retaining information about meat held on the hook. The first portion comprises a front face and a rear face and, extending from the rear face, at least one attachment member for affixing the carrier to the hook assembly. The first portion further comprises a location structure for locating the carrier in a desired location relative to the hook assembly, the location structure being arranged to cooperate with a projection on the wheel mounting.

The use of a location structure has been found to enable information carriers and associated information storage devices to be reliably located in a consistent desired location on a hook assembly without the need for careful positioning by the installer.

The invention thus provides a novel solution to the problem of applying a carrier for an information-storage device, such as an RFID transponder, to a meat transporting hook assembly in a manner such that the passing of information to and from the information-storage device is facilitated.

In one embodiment, the first portion comprises as a location structure an aperture extending from the front face to the rear face, the aperture being so located within the first portion that, when the carrier is affixed to the hook assembly by means of the attachment member(s), the aperture can be placed in register with a projection on the wheel mounting. In another embodiment, the first portion comprises as a location structure a recess in the rear face, the recess being so located in the rear face that, when the carrier is affixed to the hook assembly by means of the attachment member(s), the recess can be placed in register with a projection on the wheel mounting. The location structure advantageously enables the information carriers to be located in a predetermined position on each hook assembly with all information-storage devices being located positively in the same place, allowing for enhanced reliability and reproducibility of performance of the information-storage device, for example enabling each storage or writing device to be presented to an aerial or other reading device in substantially the same position, thereby facilitating reliable coupling.

Advantageously, the location structure is arranged to cooperate with a projection on the wheel mounting that is coincident with the axis of rotation of the wheel and preferably the location structure is so positioned that it can cooperate with a stub axle of the wheel mounting (for example, the head of a stub axle or a peened over end of a stub axle). Thus, the information carrier can be located in a fixed position relative to the wheel in a manner that necessitates no modification to the standard hook assembly.

Advantageously, the at least one attachment member comprises at least two opposing legs and preferably the at least one attachment member comprises at least two opposing, flanged legs. Advantageously, the at least one attachment member is snap-fittable to the strap. The information carrier may thus be simply attached to the hook assembly in a manner that requires no specialist tools. The information carrier may be removably affixed to the strap by the attachment member. In some forms the information carrier can be attached to the hook assembly by hand or using a soft hammer. The simple attachment mechanism may also enable easy removal (but not easy inadvertent dislodgement) of the information carrier from the hook assembly, replacement of the carrier being relatively straightforward. The carriers may be removed from the strap of the hook assemblies by breaking off the carriers. The attachment of the carrier by the attachment member has been found to be simpler than systems requiring the welding or gluing of a housing and therefore may be quicker and less expensive to fit. The attachment of carriers according to the invention may be accomplished without adhesive, welds, screws, bolts or other additional fixing means. Thus, the risk of contamination of food products can thus be reduced. The attachment member of the invention may enable the carrier to be fitted to the hook assembly or replaced when the assembly is in service in a meat processing plant without the need to remove the hook from a transport rail or interrupt meat processing.

The carrier comprises a second portion which extends from the first portion so as to position the information-storage device such that information can passed to and/or from the device. Preferably, the second portion extends laterally with respect to the strap. The positioning of the information-storage device on a second portion of the carrier that extends laterally with respect to the strap may enable the storage device to be held away from the hook assembly and in particular from ferrous metal components such as a metal strap of the wheel mounting thus improving data transfer to and from the storage device.

Advantageously, the second portion is so configured and dimensioned that, when the carrier is mounted on the strap, it does not extend beyond the outer perimeter of the wheel. Preferably, the largest dimension of the carrier is selected to be less than the diameter of the wheel. The distance from the centre of the location structure of the carrier to the end of the second portion of the carrier is advantageously less than the radius of the wheel of the hook assembly. Thus, the carrier may be protected from mechanical shocks by the wheel. Furthermore, as the carrier does not increase the overall dimensions of the hook assembly, use of the carrier will in many instances require no adaptation of meat processing plants to accommodate the use of the carrier.

Preferably, the second portion comprises a front face and a rear face, the rear face being located facing the wheel when the carrier is fitted to the strap, and there being provided in the rear face of the second portion a recessed region for receiving the information-storage device. Providing a recessed region of the carrier that faces the wheel for receiving the information-storage device has been found to enable the wheel to prevent the device from falling from the carrier should it come loose. The wheel advantageously blocks the entrance to the recess, tending to retain the tag within the recess. The second portion may comprise a cover for the recessed region.

Preferably, the information carrier is made of a polymer material. The carrier may be formed by moulding (for example, injection moulding), extruding (for example, extruding in a length and then divided into individual carriers) or machining (for example from a solid block of plastics material. The polymer material may be a plastics material, such as a thermoplastic polymer (for example, polyethylene (PE) or nylon), or a thermosetting polymer, with thermoplastic materials being preferred. Preferably, the polymer material is not metal-loaded. Advantageously, the information carrier is made of non-conductive material. The use of non-conductive material such as non-conductive polymer material may protect the tag against thermal shock for example when the hook assembly is rapidly cooled or heated when being hosed down. Constructing carriers from non-conductive material has also been found to enable improved signal connection with an information-storage device associated with a carrier to be to be achieved.

An information carrier that is made of minimum number of parts for example being moulded or extruded, or being machined from a single piece of polymer material is more hygienic than one made up of multiple parts. The carrier of the invention is advantageously constructed without screws, bolts and with a minimum number of and preferably no welds, thus reducing the number of joins between components and crevasses, rough surfaces and the like which can trap material providing a hygiene hazard.

The information-storage device may be carried on the second portion of the information carrier by any suitable fixing mechanism, for example gluing or welding. When the information carrier includes an optional recessed region, the storage device may be, if desired, glued, welded or potted (for example, sealed using a water-repellent resin) in the recessed region. The device may be sealed in the recess by the optional cover for the recessed region which may be in the form of a screw cap, a cap arranged to held in place by an interference fit, a weld plate, a plug, by a cap of resin such as epoxy resin, or any other sealing means. In a preferred embodiment, the storage device is sealed in a recess by an ultrasonically welded cover. Advantageously, removal of an information-storage device from a hook assembly may be accomplished relatively easily by removal of the carrier of the invention. Thus, the information-storage device may be removed without removing the hook assembly from a line, without interrupting meat processing and with a reduced risk of contamination of meat being processed.

The carriers, according to the invention, enable a wide variety of storage devices to be carried on the hook assembly, the devices positioned on the second portion of the carrier not being confined to any one particular geometry or make-up of storage device, for example, RFID transponders of different sizes may be received in the recessed region of the information carrier.

In one form the information carrier further comprises an information-storage device carried by, such as received within, the second portion.

In a further aspect of the invention, there is provided an information carrier for application to a meat transporting hook assembly for use in a meat processing method, which meat transporting hook assembly has a wheel, a wheel mounting embracing a portion of the wheel and comprising a strap, and a hook depending from the strap, the carrier comprising a first portion for mounting the carrier upon the strap and a second portion for carrying an information-storage device for retaining information about meat held on the hook, in which:

the first portion comprises a front face and a rear face and, extending from the rear face, at least one attachment member comprising a pair of opposing legs for embracing the strap;

the first portion further comprises a location structure for locating the carrier in a desired location relative to the hook assembly.

The invention further provides a method of retaining information about a hook and for meat retained on a hook, including the step of affixing an information carrier as described herein to a meat transporting hook assembly.

It will be appreciated that any of the optional features described above with respect to any aspect of the invention may also be incorporated into the other aspects of the invention.

### BRIEF DESCRIPTION OF THE DRAWINGS

FIG. 1A shows a plan view of an embodiment of an information carrier from the rear;

FIG. 1B shows a sectional view of the information carrier of FIG. 1A through the line A-A;

FIG. 1C shows a perspective view of the information carrier of the embodiment from the front;

FIG. 1D shows a perspective view of the information carrier of the embodiment from the rear;

FIG. 2A shows a side view of a cap for holding an information-storage device in position on the information carrier of FIGS. 1A and 1B;

FIG. 2B shows an inside plan view of the cap of FIG. 2A;

FIG. 3A shows a side view of an information-storage device suitable for carrying by the information carrier of FIGS. 1A and 1B.

FIG. 3B shows a plan view of the information-storage device of FIG. 3A.

FIG. 4 shows a partial cross-section through an information carrier of FIGS. 1A and 1B assembled with a cap of FIGS. 2A and 2B and an information-storage device of FIGS. 3A and 3B; and

FIG. 5 shows a standard US-style meat hook assembly.

### DETAILED DESCRIPTION OF A SPECIFIC EMBODIMENT

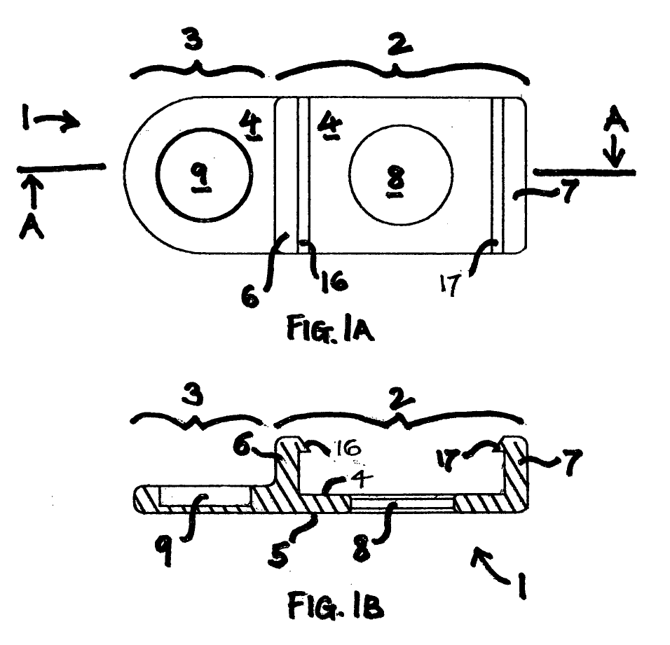

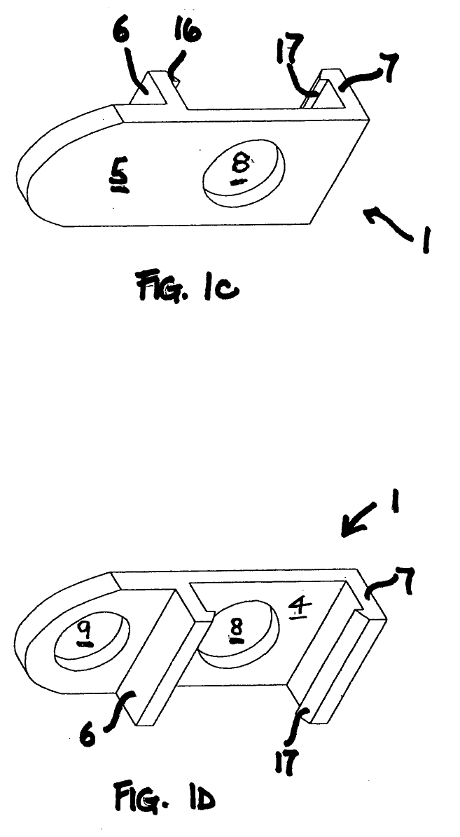

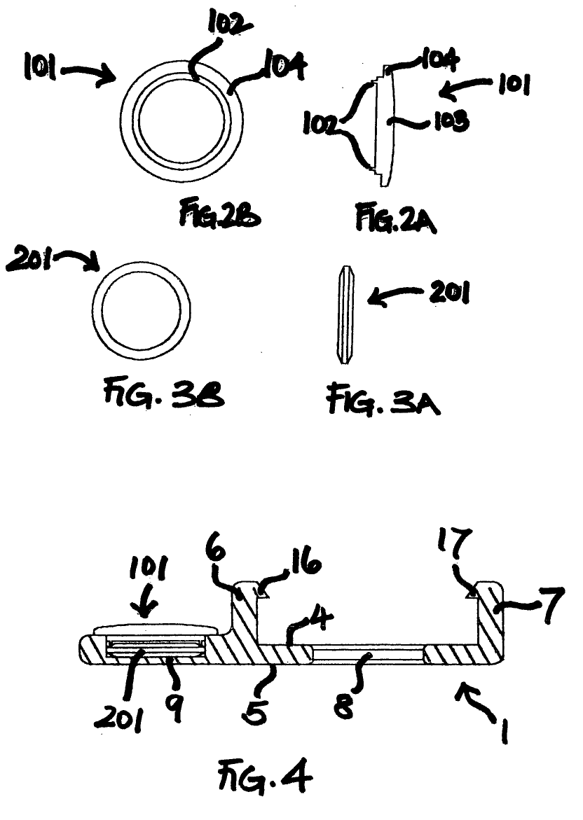

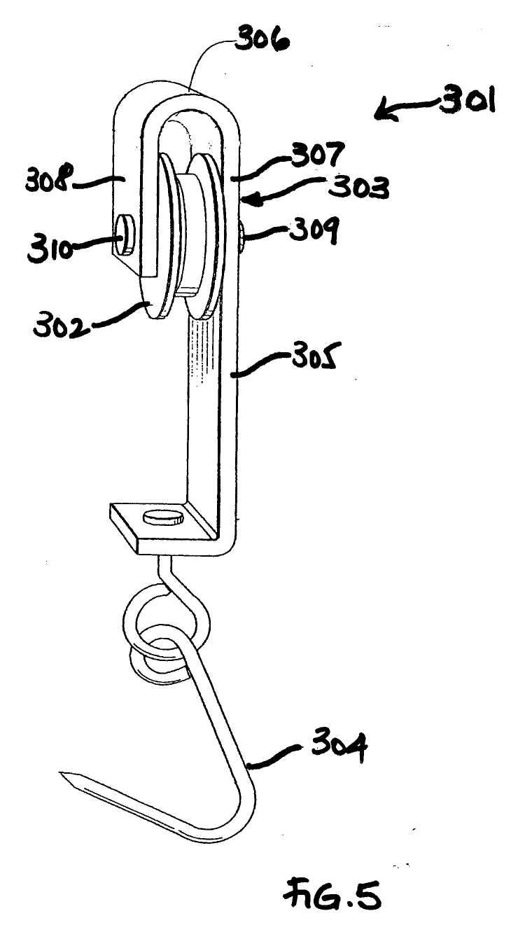

FIGS. 1A to 1D show an embodiment of an information carrier 1 for application to a standard meat hook assembly, for example, that of FIG. 5. The carrier 1 has a first portion 2 and a second portion 3. The first portion comprises a front face 5 and a rear face 4. Extending from the rear face 4 are a pair of opposed legs 6 and 7, having a proximal end attached to the main body of the carrier and a distal end remote from the body. Each of the legs includes a protrusion 16, 17 in the form of a flange at the end of the leg remote from the main body of the carrier. The protrusions 16, 17 project from the opposed legs 6, 7 towards each other. The legs 6, 7 are dimensioned and located for snugly embracing an elongate planar portion 305 of strap 303 of a meat transporting hook assembly 301 (see FIG. 5). The legs 6, 7 are resiliently deformable, the distal ends being able to move apart slightly under force. The protrusions 16, 17 are wedge-shaped so that when the carrier 1 is pushed against an object, in particular planar portion 305 of strap 303 of meat hook 301, the object acts on the protrusions 16, 17 forcing the legs 6, 7 apart to allow the object to enter the region between the legs 6, 7, and the legs 6, 7 are biased so that they then snap back into their original position. An inner face of the protrusions 16, 17 is parallel to, and faces, the rear face 4 of the first portion 2 of the main body of the carrier 1. Movement of the object away from the rear face 4 of the carrier 1 acts on the inner face of the protrusions 16, 17 and the legs 6, 7 are not forced apart. Thus, the carrier 1 is held in place on the planar portion 305 of strap 303 of the hook assembly 301, by the legs 6, 7. The first portion 2 of the carrier 1 also includes between the opposed legs 6, 7, a location structure in the form of a circular aperture 8 that extends from the front face 5 to the rear face 4. The aperture 8 is dimensioned and positioned to register with the head 309 of a wheel axle of the hook assembly 301 of FIG. 5. Thus, the legs 6, 7 and the aperture 8 function to enable the first portion 2 of the carrier 1 to be mounted on the planar portion 305 of the strap 303 and located in a consistent position relative to the projection 309. The second portion 3 of the carrier 1 comprises a front face 5 and a rear face 4 and includes a recessed region 9 for receiving an information-storage device 201 and a cap 101 (see FIG. 4). Although the information-storage device 201 illustrated in FIGS. 3A and 3B is in the form of a disc, it will be appreciated that other geometries of storage devices can also be carried by the carriers of the invention. In a preferred embodiment the information-storage device is an RFID device in the form of a wire-wound rod that operates at a frequency suitable for use in a wet environment. The recessed region 9 is cylindrical and extends into the body of the carrier from the rear face 4 of the second portion 3. Although not shown in FIGS. 1A to 1D, in a preferred embodiment, the recessed region 9 includes an inner recess portion and an outer recess portion. Both the inner recess portion and the outer recess portion 10 are cylindrical, the diameter of the inner recess portion 11 being smaller than the diameter of the outer recess portion 10. Thus, in that embodiment, the recess region 9 is stepped. The carrier 1 of the embodiment shown in FIGS. 1A to 1D is made of injection moulded polyethylene.

FIGS. 2A and 2B show a cap 101 for inserting into the recessed portion 9 of the carrier 1. The cap 101 includes a planar circular disc 103 depending from which is a flange 102 defining a cylindrical wall. The depth of the flange 102 depending from the disc 103 and the cylindrical wall defined by the flange 102 are dimensioned so that the flange 102 can be inserted into the recess portion 9 on the rear face 4 of the carrier 1. The diameter of the disc 103 is larger than the flange 102 so that a lip surface 104 of the disc rests against the rear surface 4 of the second portion 3 of the carrier 1 when the cap 101 is inserted in the recess portion 9 of the carrier 1. The cap 101 is moulded from ultrasonically weldable plastic. Although not shown in FIGS. 2A and 2B, in a preferred embodiment the cap 101 includes either a recessed part or a protruding part (for example an annular groove, or a protruding ring) around the outside of the cylindrical wall defined by the flange 102 and it is also preferred that the recessed portion 9 includes a corresponding mating part (for example, a protrusion or a groove). When the cap 101 is inserted in the recessed region 9, the complementary recessed and protruding parts register with one another to mechanically hold the cap 101 in place.

FIGS. 3A and 3B show an information-storage device in the form of a circular disc-shaped RFID transponder 201. The recess region 9 of the carrier 1 is dimensioned so that it can receive a range of different information-storage device geometries including the disc-shaped transponder 201 illustrated and rod-like transponders, the diameter and the depth of the recess portion 9 being greater than the dimensions of the information-storage devices.

FIG. 4 shows an assembled arrangement of an information carrier 1, a transponder 201 and a cap 101. The transponder 201 is located in the recess portion 9 of the second portion 3 of the carrier 1. The cap 101 is inserted on top of the transponder 201 in the recess portion 9 of the carrier 1 and then ultrasonically welded in place.

FIG. 5 shows a standard meat transporting hook assembly 301 of the type already known in the art. The hook assembly 301 has a wheel 302 for running on a rail (not shown), and a wheel mounting comprising a strap 303 and a hook 304. The strap 303 includes an elongate planar portion 305 having a lower end from which the hook 304 depends and an upper end region from which there extends a portion of the strap 303 that is turned over to form a loop 306 that embraces a portion of the wheel 302. The planar portion 305 and loop portion 306 are formed in one piece. At the upper end of the elongate planar portion 305 a main portion 307 of the strap 303 is adjacent to one face of the wheel 302 and a return portion 308 of the strap 303 is adjacent to the other face of the wheel 302. An axis (not shown) passes through the centre of the wheel 302. The wheel mounting includes an axle (not shown) that runs from a head portion (or axle stub) 309 on the outside of the main portion 307 of the strap 303 along the axis of the wheel and projects through the return portion 308 of the strap 303. The end 310 of the axle that projects through the return portion 308 is shown in FIG. 5 as being peened to flatten out the end of the axle to retain the axle in place. Although the orientation of the axle illustrated in FIG. 5 is the usual construction, it will be appreciated that, on occasion, the axle can be inserted in the opposite direction with the head portion 309 adjacent to the return portion 308 and the peened end 310 of the axle adjacent to the main portion 307 of the strap 303. The head portion 309 and the end portion 310 form a pair of projections 309 on the wheel mounting.

In use, the information carrier 1, RFID transponder 201 and cap 101 are assembled as shown in FIG. 4. The cap 101 is welded in place in the recess region 9 by ultrasonic or other welding (for example, solvent welding), thereby affixing the transponder 201 and the cap 101 in the recess region 9. The assembly comprising the carrier 1, transponder 201 and cap 101 is then applied to the meat transporting hook assembly 301 shown in FIG. 5. The legs 6, 7 of the carrier 1 are placed either side of the strap 303 of the hook assembly 301 so that the rear face 4 of the first portion 2 of the carrier 1 faces the strap 303. The carrier 1 is positioned on either the main portion 307 or the return portion 308 of the strap 303 so that the aperture 8 in the first portion 2 is aligned with a selected one of the projections 309, 310. Preferably, the carrier 1 is positioned on the main portion 307 of the strap 303. The carrier 1 is then affixed to the wheel mounting, for example, by tapping the front face 5 of the first portion 2 with a soft hammer (not shown). On tapping the front face 5, the legs 6, 7 deform outwards relative to one another slightly due to the interaction between the strap 303 and the wedge-shaped angled protrusions 16, 17. The strap 303 passes between the protrusions 16, 17 and once the strap 303 has past the protrusions 16, 17, the legs 6, 7 snap back into their original positions towards which they are resiliently biased. The carrier is then held in a position on the hook assembly 301 by the legs 6, 7, the carrier 1 gripping the strap 303 between the rear face 4 of the first portion 2 of the carrier 1 by the protrusions 16, 17. One of the projections 309, 310 on the wheel mounting is in register with the aperture 8, which acts as a location structure, locating the carrier 1 in a position relative to the projection 309, 310. The carrier 1 is usually aligned on the main portion 307 of the strap 303 by means of the aperture 8 registering with the head portion 309 of the axle, although it can also be aligned by registration of the aperture 8 with the end 310 of the axle. The second portion 3 of the carrier 1 extends laterally with respect to the strap 303. The rear face 4 of the second portion 3, that includes the recess region 9 in which the transponder 201 and cap 101 are affixed, faces the side of the wheel 302. Should the weld fail, the cap 101 and the transponder 201 will be held in the recess 9 by the wheel 302 preventing them from coming away from the carrier 1. The positioning of the transponder 201 by the carrier 1 in a position removed from the metal of the strap 303 enables a more reliable electronic coupling to be achieved with the transponder 201 than when it is in close contact with a metal strap.

It will be appreciated by persons skilled in the art, that the embodiments of the present invention are not limited to what has been particularly shown and described hereinabove and the invention may be embodied in other specific forms without departing from the spirit of the invention. The scope of the present invention is defined by the appended claims and includes both combinations and subcombinations of the various features described hereinabove as well as variations and modifications thereof which would occur to persons skilled in the art upon reading the foregoing description.

1. An information carrier for application to a meat transporting hook assembly for use in a meat processing method, which meat transporting hook assembly has a wheel, a wheel mounting embracing a portion of the wheel and comprising a strap, and a hook depending from the strap, the carrier comprising a first portion for mounting the carrier upon the strap and a second portion for carrying an information-storage device for retaining information about meat held on the hook, in which;
the first portion comprises a front face and a rear face and, extending from the rear face, at least one attachment member for affixing the carrier to the hook assembly;
the first portion further comprises a location structure for locating the carrier in a desired location relative to the hook assembly, the location structure being arranged to cooperate with a projection on the wheel mounting;
the second portion extends from the first portion so as to position the information-storage device such that information can pass to and/or from the device.

2. An information carrier according to claim 1, in which the first portion comprises as a location structure an aperture extending from the front face to the rear face, the aperture being so located within the first portion that, when the carrier is affixed to the hook assembly by means of the attachment member(s), the aperture can be placed in register with a projection on the wheel mounting.

3. An information carrier according to claim 1, in which the first portion comprises as a location structure a recess in the rear face, the recess being so located in the rear face that, when the carrier is affixed to the hook assembly by means of the attachment member(s), the recess can be placed in register with a projection on the wheel mounting.

4. An information carrier according to claim 1, in which the location structure is arranged to cooperate with a projection on the wheel mounting that is coincident with the axis of rotation of the wheel.

5. An information carrier according to claim 4, in which the location structure is so positioned that it can cooperate with a stub axle of the wheel mounting.

6. An information carrier according to claim 1, in which the at least one attachment member comprises at least two opposing legs.

7. An information carrier according to claim 1, in which the at least one attachment member comprises at least two opposing, flanged legs.

8. An information carrier according to claim 1, in which the at least one attachment member is snap-fittable to the strap.

9. An information carrier according to claim 1, in which the second portion is so configured and dimensioned that, when the carrier is mounted on the strap, it does not extend beyond the outer perimeter of the wheel.

10. An information carrier according to claim 1, in which the largest dimension of the carrier is selected to be less than the diameter of the wheel.

11. An information carrier according to claim 1, in which the second portion extends laterally with respect to the strap.

12. An information carrier according to claim 11, in which the second portion comprises a front face and a rear face, the rear face being located facing the wheel when the carrier is fitted to the strap, and there is provided in the rear face of the second portion a recessed region for receiving the information-storage device.

13. An information carrier according to claim 12, in which the second portion comprises a cover for the recessed region.

14. An information carrier according to claim 1, wherein the carrier is made of a polymer material.

15. An information carrier according to claim 1, further comprising an information-storage device received within the second portion.

16. An information carrier according to claim 15, wherein the information-storage device is a radio frequency identification (RFID) device.

17. An information carrier for application to a meat transporting hook assembly for use in a meat processing method, which meat transporting hook assembly has a wheel, a wheel mounting embracing a portion of the wheel and comprising a strap, and a hook depending from the strap, the carrier comprising a first portion for mounting the carrier upon the strap and a second portion for carrying an information-storage device for retaining information about meat held on the hook, in which:
the first portion comprises a front face and a rear face and, extending from the rear face, at least one attachment member comprising a pair of opposing legs for embracing the strap;
the first portion further comprises a location structure for locating the carrier in a desired location relative to the hook assembly.

18. An information carrier according to claim 17, in which the at least one attachment member is snap-fittable to the strap.

19. A method of retaining information relating to a hook including the step of affixing an information carrier to a meat transporting hook assembly for use in a meat processing method, which meat transporting hook assembly has a wheel, a wheel mounting embracing a portion of the wheel and comprising a strap, and a hook depending from the strap, the carrier comprising a first portion for mounting the carrier upon the strap and a second portion for carrying an information-storage device for retaining information about meat held on the hook, in which:
the first portion comprises a front face and a rear face and, extending from the rear face, at least one attachment member for affixing the carrier to the hook assembly, the location structure being arranged to cooperate with a projection on the wheel mounting;
the first portion further comprises a location structure for locating the carrier in a desired location relative to the hook assembly;
the second portion extends from the first portion so as to position the information-storage device such that information can pass to and/or from the device.
